(19) United States
(12) Patent Application Publication
(10) Pub. No.: US 2026/0187751 A1
(43) Pub. Date: Jul. 2, 2026

(54) VIDEO PROCESSING METHOD AND APPARATUS, AND ELECTRONIC DEVICE

(71) Applicant: DOUYIN VISION CO., LTD., Beijing (CN)

(72) Inventors: Jing CHENG, Beijing (CN); Yangchen XIE, Beijing (CN)

(21) Appl. No.: 19/130,096

(22) PCT Filed: Feb. 5, 2024
(86) PCT No.: PCT/CN2024/076011

§ 371 Date: May 14, 2025

(30) Foreign Application Priority Data
Feb. 15, 2023 (CN) 202310147152.3

(51) Int. Cl. G06T 3/04; G06T 3/40; G06T 7/73; G06V 10/25; G06V 20/40; H04N 7/01

(52) U.S. Cl. CPC G06T 3/04; G06T 3/40; G06T 7/74; G06V 10/25; G06V 20/46; H04N 7/0122; G06T 2207/10016; G06T 2207/20132; G06V 2201/07

(57) ABSTRACT

The present disclosure provides a video processing method and apparatus, and an electronic device. A specific implementation of the method includes: acquiring a target set, where the target set includes a first feature vector corresponding to a target object, and the first feature vector is obtained based on an image corresponding to the target object; acquiring a first video frame to be played; determining a target feature vector of the first video frame; and determining, based on the target set and the target feature vector, a target video frame associated with the first video frame.

The present application is based on and claims priority to Chinese Patent Application No. 202310147152.3, filed on Feb. 15, 2023, the disclosure of which is incorporated herein by reference in its entirety.

### TECHNICAL FIELD

The present disclosure relates to the technical field of video processing, and in particular, to a video processing method and apparatus, and an electronic device.

### BACKGROUND

With the continuous development of the Internet technology and the terminal technology, videos are increasingly played on various terminal devices, and the various terminal devices may have different display sizes. Generally, when playing a video, the terminal device performs scaling on the video according to an aspect ratio of the video and an aspect ratio of a playing window, so that the video picture can be completely displayed in the playing window of the display screen.

### SUMMARY

According to some embodiments of the present disclosure, a video processing method and apparatus, and an electronic device are provided.

According to a first aspect, a video processing method is provided. The method includes:
acquiring a target set, where the target set includes a first feature vector corresponding to a target object, and
the first feature vector is obtained based on an image corresponding to the target object;
acquiring a first video frame to be played;
determining a target feature vector of the first video frame; and
determining, based on the target set and the target feature vector, a target video frame associated with the first video frame.

According to a second aspect, a video processing apparatus is provided. The apparatus includes:
a first acquiring module, configured to acquire a target set, where the target set includes a first feature vector corresponding to a target object, and the first feature vector is obtained based on an image corresponding to the target object;
a second acquiring module, configured to acquire a first video frame to be played;
a first determining module, configured to determine a target feature vector of the first video frame; and
a second determining module, configured to determine, based on the target set and the target feature vector, a target video frame associated with the first video frame.

According to a third aspect, a computer-readable storage medium is provided. The storage medium is stored with a computer program which, when executed by a processor, implements the method according to any one of the above first aspect.

According to a fourth aspect, an electronic device is provided. The electronic device includes a memory, a processor, and a computer program stored in the memory and executable by the processor. The processor, when executing the program, implements the method according to any one of the first aspect.

It should be understood that the above general description and the following detailed description are only exemplary and explanatory, and cannot limit the present disclosure.

### BRIEF DESCRIPTION OF THE DRAWINGS

In order to illustrate the technical solutions of the embodiments of the present specification more clearly, the following will briefly introduce the drawings that need to be used in the description of the embodiments. Obviously, the drawings in the following description are only some embodiments recorded in the present specification, and those skilled in the art can obtain other drawings according to these drawings without creative effort.

FIG. 1 is a schematic diagram of a video cropping scene according to an exemplary embodiment of the present disclosure;

FIG. 2A is a flowchart of a video processing method according to an exemplary embodiment of the present disclosure;

FIG. 2B is a flowchart of another video processing method according to an exemplary embodiment of the present disclosure;

FIG. 3 is a flowchart of another video processing method according to an exemplary embodiment of the present disclosure;

FIG. 4 is a block diagram of a video processing apparatus according to an exemplary embodiment of the present disclosure;

FIG. 5 is a schematic block diagram of an electronic device according to some embodiments of the present disclosure;

FIG. 6 is a schematic block diagram of another electronic device according to some embodiments of the present disclosure; and

FIG. 7 is a schematic diagram of a storage medium according to some embodiments of the present disclosure.

### DETAILED DESCRIPTION OF EMBODIMENTS

In order to enable those skilled in the art to better understand the technical solutions in the present specification, the technical solutions in the embodiments of the present specification will be clearly and completely described below with reference to the drawings in the embodiments of the present specification. Obviously, the described embodiments are only a part of the embodiments of the present specification, but not all of them. Based on the embodiments in the present specification, all other embodiments obtained by those of ordinary skill in the art without creative effort shall fall within the scope of protection of the present specification. When the following description refers to the drawings, the same numbers in different drawings refer to the same or similar elements unless otherwise indicated. The implementations described in the following exemplary embodiments do not represent all implementations consistent with the present disclosure. On the contrary, they are only examples of apparatuses and methods consistent with some aspects of the present disclosure as detailed in the appended claims.

The terms used in the present disclosure are only for the purpose of describing specific embodiments, and are not intended to limit the present disclosure. Singular forms of “a”, “said” and “the” used in the present disclosure are also intended to include plural forms, unless the context clearly indicates other meanings. It should also be understood that the term “and/or” as used herein refers to and includes any or all possible combinations of one or more associated listed items.

It should be understood that although various information may be described in the present disclosure by using terms such as first, second, third, etc., these information should not be limited to these terms. These terms are only used to distinguish the same type of information from each other. For example, without departing from the scope of the present disclosure, the first information may also be referred to as the second information, and similarly, the second information may also be referred to as the first information. Depending on the context, the word “if” as used herein may be interpreted as “when”, “while” or “in response to determining”.

With the continuous development of the Internet technology and the terminal technology, videos are increasingly played on various terminal devices, and the various terminal devices may have different display sizes. Generally, when playing a video, the terminal device performs scaling on the video according to an aspect ratio of the video and an aspect ratio of a playing window, so that the video picture can be completely displayed in the playing window of the display screen. However, if the aspect ratio of the video is greatly different from the aspect ratio of the playing window, the video picture will be compressed to be very small, and a large number of idle areas (i.e., black areas) will appear on the left and right or up and down of the display screen, which greatly affects the user's viewing experience.

In the related art, some key video frames are usually extracted from an original video, and for each extracted key video frame, a focus area of the key video frame is predicted by using a complex video understanding technology, and then the key video frame is cropped according to the aspect ratio of the playing window based on the focus area. Then, cropping information of non-key video frames between the key video frames is calculated, and the non-key video frames are cropped according to the cropping information. However, the above cropping manner has a large amount of computation, resulting in serious delay in video playing. Moreover, in a live streaming or rebroadcasting scene, if the above manner is adopted to crop the original video, a serious delay in video playing will be caused, and the playing effect of the cropped video is also poor. A video processing method provided by the present disclosure determines a target video frame associated with a first video frame to be played based on a feature vector corresponding to a target object that is pre-stored. Thus, in a live streaming or rebroadcasting scene, video playing is performed based on the target video frame associated with a real-time video being played, and a video picture of the target video frame can be completely displayed in a playing window of a display screen, thereby improving the effect and efficiency of video playing and enhancing the user experience.

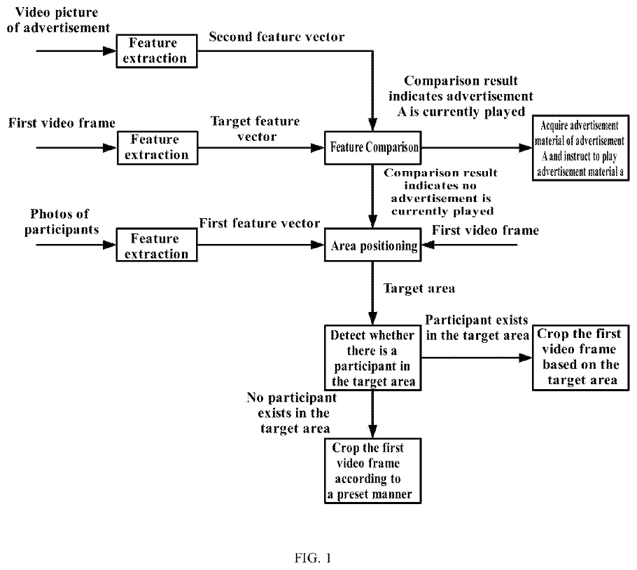

Referring to FIG. 1, it is a schematic diagram of a video cropping scene according to an exemplary embodiment. The solution of the present disclosure will be schematically illustrated below with reference to FIG. 1 and in conjunction with a complete and specific application example. The application example describes a specific process of video cropping.

As shown in FIG. 1, taking a scene of live streaming of a sports event as an example, before the live streaming of the event starts, photos of all participants may be acquired in advance, and a first feature vector of each participant in the photos may be extracted. In addition, during the live streaming of the event, pre-recorded advertisements will be inserted, therefore, video pictures of all advertisements that need to be inserted during the live streaming of the event may also be acquired, and a second feature vector of the video picture of each advertisement may be extracted. A target set is constituted by the first feature vector and the second feature vector, and the target set is stored. Advertisement materials corresponding to respective advertisements may also be acquired to constitute a material library, and the material library is stored. The advertisement material may be a material in the form of an image or a material in the form of a video, and the specific form of the advertisement material is not limited in this embodiment. In addition, a picture of the advertisement material satisfies a preset aspect ratio.

After the live streaming of the event starts, a first video frame that is about to be played currently is acquired, and a target feature vector corresponding to the first video frame is extracted. Firstly, the target feature vector is compared with a second feature vector corresponding to the video picture of each advertisement in the target set (for example, calculating a similarity between the target feature vector and the second feature vector corresponding to each advertisement), and whether an advertisement is being played currently is determined according to a comparison result. For example, if advertisement A is being played currently, the comparison result indicates that a similarity between the target feature vector and a second feature vector corresponding to the advertisement A is greater than a preset threshold. If no advertisement is being played currently, the comparison result indicates that a similarity between the target feature vector and a second feature vector corresponding to each advertisement is less than a preset threshold.

If it is determined, according to the comparison result, that the advertisement A is being played currently, an advertisement material “a” corresponding to the advertisement A may be taken out from the material library, and the advertisement material “a” is played according to a duration corresponding to the advertisement A. If it is determined, according to the comparison result, that no advertisement is being played currently, area positioning may be further performed for the participant in the first video frame according to the first feature vector in the target set, to determine a target area in the first video frame.

In some embodiments, in one case, if the previous video frame of the first video frame includes the participant, position information and feature information of the target area corresponding to the participant in the previous video frame may be acquired. Then, the area positioning is performed for the participant in the first video frame based on the previous video frame, to obtain the target area in the first video frame. In another case, if the participant does not appear in the previous video frame of the first video frame, the area positioning is performed for the participant in the first video frame according to the first video frame and the first feature vector in the target set, to obtain the target area in the first video frame.

It should be noted that even if the participant does not appear in the first video frame, the target area may also be located through the above process, therefore, the located target area may not include the participant. Therefore, after determining the target area in the first video frame, whether the participant exists in the target area needs to be detected. In some embodiments, a feature vector corresponding to the located target area in the first video frame may be extracted, and the feature vector corresponding to the target area is compared with the first feature vector in the target set. If it is determined, according to a comparison result, that the participant does not exist in the target area, the first video frame may be cropped into the target video frame that satisfies the preset aspect ratio according to a preset manner. For example, the target video frame is obtained by cropping with a center of a region of interest (ROI) in the first video frame as a cropping center according to the preset aspect ratio. The region of interest in the first video frame may be a region including a person, a specified object or a text. If it is determined, according to the comparison result, that the participant exists in the target area, a target box covering the target area and having a size that satisfies the preset aspect ratio may be generated. And the current video frame is cropped into the target video frame based on the target box.

The present disclosure will be described in detail below with reference to specific embodiments.

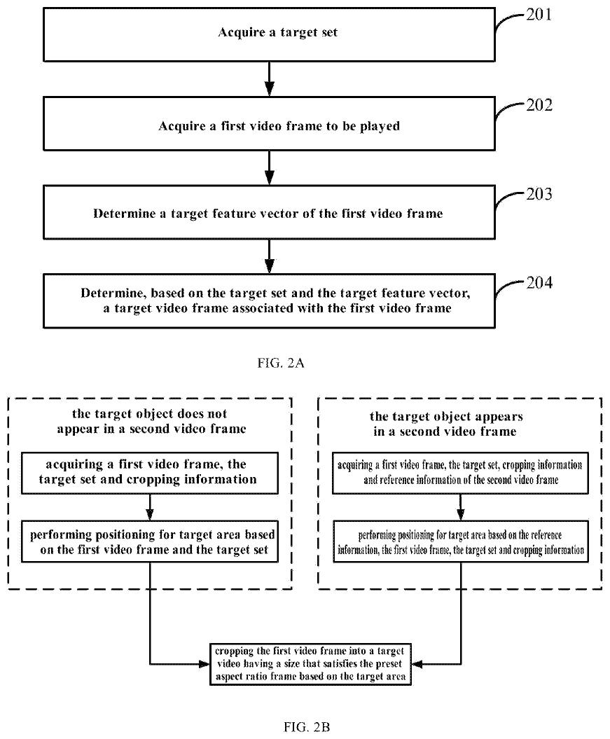

FIG. 2A is a flowchart of a video processing method according to an exemplary embodiment. The method may be applied to a server or a terminal device. The method may include the following steps.

As shown in FIG. 2A, in step 201, a target set is acquired, and in step 202, a first video frame to be played is acquired.

In this embodiment, the involved video may be a video that is played in real time in a live streaming or rebroadcasting scene, for example, a video of a sports event that is live streamed or rebroadcast, or a video of a concert that is live streamed or rebroadcast. Before live streaming or rebroadcasting the video, a first feature vector corresponding to a target object may be extracted in advance based on an image corresponding to the target object, and the target set is constituted by the first feature vector. The target object may be a focus object that is most likely to be focused on in the video to be played. For example, if the video to be played is a video of a sports event, the target object may be respective participants, balls, etc. For another example, if the video to be played is a video of a concert, the target object may be a main singer of the concert, etc.

In some embodiments, multiple images that can reflect different angles of the target object may be acquired in advance, and a plurality of high-dimensional feature vectors of the multiple images are extracted by using a pre-trained convolutional neural network, to be used as the first feature vectors. The target set is constituted by the first feature vectors, and the target set is stored. The first feature vector may be an embedded feature vector. Since the video is played frame by frame, during the process of video playing, video frames can be cropped frame by frame in real time. In some embodiments, the first video frame that is about to be played may be acquired, and the first video frame is cropped to obtain the target video frame. After the cropping of the first video frame is completed and the target video frame is obtained, the target video frame can be played.

In step 203, a target feature vector of the first video frame is determined, and in step 204, a target video frame associated with the first video frame is determined based on the target set and the target feature vector.

In this embodiment, the area positioning may be performed for the target object in the first video frame based on at least the first video frame and the first feature vector included in the target set, to obtain at least one target area in the first video frame. For example, the area positioning may be performed for the target object in the first video frame by using a machine learning manner. In some embodiments, a person re-identification (Re-Identification, Re-ID) method may be used, where the first feature vector included in the target set and the first video frame are input into a pre-trained Re-ID model, to obtain information about the target area output by the Re-ID model.

For another example, a preset algorithm may also be used to generate multiple candidate boxes in the first video frame by means of a sliding window, etc., and then feature vectors are extracted for regions in the candidate boxes through a scale-invariant feature transform (SIFT) method or a histogram of oriented gradient (HOG) method, etc., and then a region in a target candidate box is selected as the target area according to a distance between feature vectors of the regions in the candidate boxes and the first feature vector included in the target set. Alternatively, a support vector machine (SVM) method is used to select the region in the target candidate box as the target area.

In some embodiments, whether the target object exists in a second video frame may be determined first, where the second video frame is a previous video frame of the first video frame. In a case where the target object does not appear in the second video frame, the area positioning may be performed for the target object in the first video frame based on the first video frame and the target set by using the above machine learning manner or preset algorithm. In a case where the target object exists in the second video frame, reference information corresponding to the second video frame may be acquired, where the reference information includes position information and feature information corresponding to the target area in the second video frame. The target area in the second video frame is an area where the target object exists in the second video frame. Then, the area positioning may be performed for the target object in the first video frame based on the reference information, the first video frame and the target set.

For example, a machine learning manner may be used, where the reference information, the first video frame and the target set are input into a pre-trained model, to perform the area positioning for the target object in the first video frame, to obtain the target area in the first video frame. For another example, a minimum output sum square error (MOSSE) tracking algorithm or an exploiting the circulant structure of tracking-by-detection with kernels (CSK) algorithm may also be used, to perform the area positioning for the target object in the first video frame based on the reference information, the first video frame and the target set, to obtain the target area in the first video frame.

In this embodiment, in a case where the target object appears in the previous video frame, the area positioning is performed by referring to the information of the target area of the previous video frame, which improves the processing efficiency and processing effect.

FIG. 2B is a comparison between a processing process when the target object does not appear in the second video frame and a processing process when the target object appears in the second video frame. As shown in FIG. 2B, when the target object does not appear in the second video frame, the first video frame, the target set, and cropping information (for example, cropping size, etc.) are acquired, and then the target area is located based on the first video frame and the target set. Finally, the first video frame is cropped into a target video frame that satisfies the preset aspect ratio based on the target area. When the target object appears in the second video frame, the first video frame, the target set, the cropping information (for example, cropping size, etc.), and reference information in the second video frame (for example, position information and feature information corresponding to the target area in the second video frame, etc.) are acquired. Then, the target area is located based on the reference information, the first video frame, the target set, and the cropping information. Since the reference information in the second video frame is used, the location range can be narrowed, and the location speed can be improved. Finally, the first video frame is cropped into a target video frame that satisfies the preset aspect ratio based on the target area.

In this embodiment, even if the target object does not appear in the first video frame, the target area may also be located, therefore, the target object may not exist in the located target area. Therefore, after determining the target area in the first video, whether the target object exists in the target area needs to be detected. In some embodiments, a feature vector may be extracted for the target area, and then the feature vector of the target area is compared with the first feature vector included in the target set, to determine whether the target object exists in the target area.

In a case where the target object does not exist in the target area, the first video frame may be cropped into the target video frame that satisfies the preset aspect ratio according to the preset manner. In some embodiments, in an implementation, an edge of a cropping box may be determined according to the preset aspect ratio by using a center of the first video frame as a center of the cropping box, and the first video frame is cropped into the target video frame according to the cropping box. In another implementation, an ROI region in the first video frame may also be determined, and the first video frame is cropped into the target video frame according to the preset aspect ratio by using a center of the ROI region as the center of the cropping box.

In a case where the target object exists in the target area, a target box covering the target area and having a size that satisfies the preset aspect ratio may be generated. For example, the target box is generated according to the preset aspect ratio by using a center of the target area as a center of the target box. Then, the target box is used as the cropping box, and the first video frame is cropped into the target video frame. In some embodiments, a position of the target box may also be corrected by using a Kalman filter to obtain a corrected cropping box, and the first video frame is cropped into the target video frame according to the cropping box. In this embodiment, the position of the target box is corrected by using the Kalman filter, so that the video jitter can be prevented.

It should be noted that the method may be executed by a server or a terminal device. If the method is executed by the server, the server may crop the original video frame for various different playing requirements, to obtain video frames that satisfy different aspect ratio standards. Then, the video frames with corresponding aspect ratios are transmitted to different users according to the needs of different users. For example, currently commonly used playing aspect ratios include aspect ratio a, aspect ratio b, and aspect ratio c. The server may generate video frame 1 that satisfies aspect ratio a, video frame 2 that satisfies aspect ratio b, and video frame 3 that satisfies aspect ratio c, respectively, and then, the server may transmit video frame 1 to user A and transmit video frame 2 to user B, etc. according to requests of the users.

If the method is executed by the terminal device, the terminal device may determine the preset aspect ratio of the playing video according to the playing mode selected by the user. The terminal device receives the original video frame transmitted by the server, crops the original video frame according to the preset aspect ratio, to obtain a target video frame that satisfies the preset aspect ratio, and plays the target video frame.

A video processing method provided by the present disclosure determines a target video frame associated with a first video frame to be played based on a feature vector corresponding to a target object that is pre-stored. Thus, in a live streaming or rebroadcasting scene, video playing is performed based on the target video frame associated with a real-time video being played, and a video picture of the target video frame can be completely displayed in a playing window of a display screen, thereby improving the effect and efficiency of video playing and enhancing the user experience.

FIG. 3 is a flowchart of another video processing method according to an exemplary embodiment. The method may be applied to a server or a terminal device. The method may include the following steps.

As shown in FIG. 3, in step 301, a first video frame to be played is acquired, and in step 302, a pre-stored target set is acquired.

In this embodiment, before live streaming or rebroadcasting of the video, in addition to extracting the first feature vector corresponding to the target object in advance based on the image corresponding to the target object, the second feature vector corresponding to each recorded video to be inserted may be also extracted in advance based on the video frame of each recorded video to be inserted, and the target set is constituted by the first feature vector and the second feature vector. The target object may be a focus object that is most likely to be focused on in the video to be played, and the recorded video may be an advertisement video that needs to be inserted during the process of live streaming or rebroadcasting the video, or a promotional video that needs to be inserted, etc.

In some embodiments, multiple images that can reflect different angles of the target object may be acquired in advance, and a plurality of high-dimensional feature vectors of the multiple images are extracted by using a pre-trained convolutional neural network, to be used as the first feature vectors. The video frame of the recorded video that needs to be inserted during the process of live streaming or rebroadcasting of the video is acquired, and a high-dimensional feature vector of the video frame of the recorded video is extracted by using the pre-trained convolutional neural network, to be used as the second feature vector. Then, the target set is constituted by the first feature vector and the second feature vector, and the target set is stored. The first feature vector and the second feature vector may both be embedded feature vectors.

In addition, the material corresponding to each recorded video to be inserted may also be acquired in advance to constitute a material library, and the material library is stored. The material may be a material in the form of an image or a material in the form of a video. In addition, a size corresponding to a picture of the material satisfies the preset aspect ratio. Different material libraries may be set according to different preset aspect ratios. For example, currently commonly used playing aspect ratios include aspect ratio a, aspect ratio b, and aspect ratio c. Material library al corresponding to aspect ratio a, material library bl corresponding to aspect ratio b, and material library cl corresponding to aspect ratio c may be generated, respectively. For each recorded video to be inserted, the material that satisfies aspect ratio a, the material that satisfies aspect ratio b, and the material that satisfies aspect ratio c may be generated respectively, and the generated material is stored into a corresponding material library.

In step 303, whether the first video frame is a video frame of a recorded video inserted during live streaming is determined, and in step 304, if the first video frame is the video frame of the recorded video inserted during live streaming, a target material corresponding to the recorded video is acquired and the target material is played.

The recorded video inserted during live streaming may be a pre-recorded advertisement video, a promotional video, or a small program inserted during live streaming. Firstly, a high-dimensional feature vector of the first video frame may be extracted by using a pre-trained convolutional neural network, to be used as a target feature vector corresponding to the first video frame. The target feature vector may be an embedded feature vector. Then, the target feature vector is compared with the second feature vector included in the target set, to determine whether the first video frame is the video frame of the recorded video inserted during live streaming. In some embodiments, if a comparison result indicates that the target feature vector matches with a second feature vector corresponding to a video frame of any recorded video in the target set, it is determined that the first video frame is the video frame of the recorded video inserted during live streaming. The target material corresponding to the recorded video may be acquired from a material library corresponding to the preset aspect ratio according to the preset aspect ratio, and the target material is played. Here, the target material refers to an image or a recorded video having a preset aspect ratio. If the comparison result indicates that the target feature vector does not match with all second feature vectors in the target set, it is determined that the first video frame is not the video frame of the recorded video inserted during live streaming.

In step 305, if the first video frame is not the video frame of the recorded video inserted during live streaming, a target area in the first video frame is determined based on the target set, and the first video frame is cropped according to the preset aspect ratio based on the target area, to obtain the target video frame.

It should be noted that, for the same steps as those in the embodiment of FIG. 2A, details will not be repeated in the above embodiment of FIG. 3, and reference may be made to the embodiment of FIG. 2A for related content.

In a video processing method provided by the present disclosure, whether the first video frame is the video frame of the recorded video inserted during live streaming is determined based on the pre-extracted second feature vector corresponding to the recorded video. If the first video frame is the video frame of the recorded video inserted during live streaming, the target material corresponding to the recorded video is directly acquired and the target material is played. If the first video frame is not the video frame of the recorded video inserted during live streaming, a target area is further determined from the first video frame based on a first feature vector corresponding to a target object, and the video cropping is performed based on the target area, to obtain a target video frame to be played. Thus, the real-time cropping of the video frame is realized without increasing the playing delay, and the effect and efficiency of video cropping are improved. Moreover, for the recorded video inserted during live streaming, the material corresponding to the recorded video is directly played, which further alleviates the playing delay caused by video cropping, and further improves the user experience.

It should be noted that although operations of the method of the embodiments of the present disclosure are described in a specific order in the above embodiments, this does not require or imply that these operations must be performed in this specific order, or that all illustrated operations must be performed to achieve a desired result. On the contrary, the steps depicted in the flowchart may change the execution order. Additionally or alternatively, some steps may be omitted, multiple steps may be combined into one step for execution, and/or one step may be decomposed into multiple steps for execution.

Corresponding to the foregoing embodiments of the video processing method, the present disclosure also provides an embodiment of a video processing apparatus.

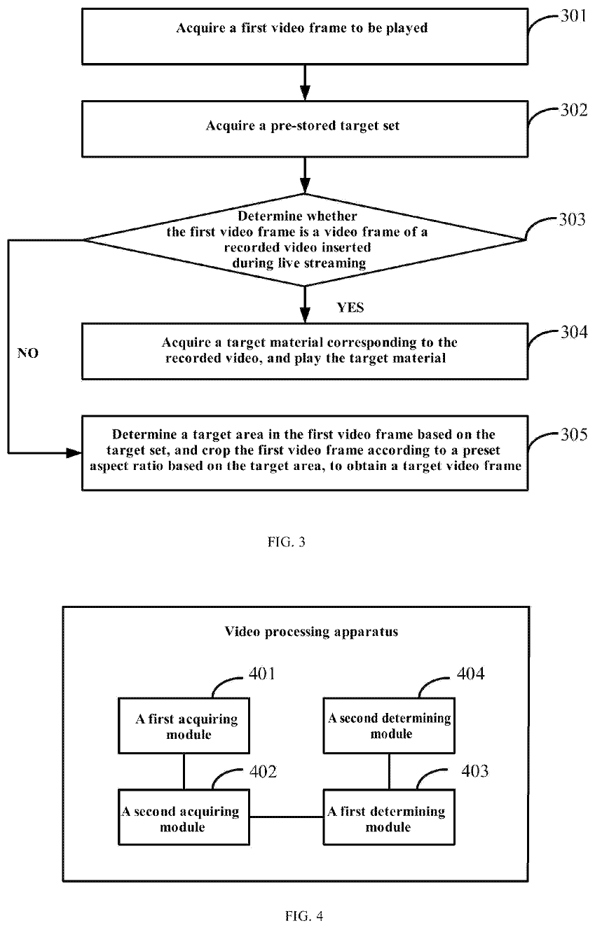

As shown in FIG. 4, it is a block diagram of a video processing apparatus according to an exemplary embodiment of the present disclosure. The apparatus may include: a first acquiring module 401, a second acquiring module 402, a first determining module 403, and a second determining module 404.

The first acquiring module 401 is configured to acquire a target set, where the target set includes a first feature vector corresponding to a target object, and the first feature vector is obtained based on an image corresponding to the target object.

The second acquiring module 402 is configured to acquire a first video frame to be played.

The first determining module 403 is configured to determine a target feature vector of the first video frame.

The second determining module 404 is configured to determine, based on the target set and the target feature vector, a target video frame associated with the first video frame.

In some implementations, the second determining module 404: determines a target area in the first video frame based on the target set and the target feature vector, and crops the first video frame based on the target area, to obtain the target video frame.

In some other implementations, the second determining module 404 determines the target area in the first video frame based on the target set and the target feature vector by: performing, in the first video frame, area positioning for the target object based on at least the target set and the target feature vector, to obtain at least one target area in the first video frame.

In some other implementations, the second determining module 404 performs, in the first video frame, the area positioning for the target object based on at least the target set and the target feature vector by:
if the target object does not appear in a second video frame which is a previous frame of the first video frame, performing, in the first video frame, the area positioning for the target object based on the target set and the target feature vector; and if the target object appears in the second video frame, performing, in the first video frame, the area positioning for the target object based on the target set, the target feature vector, and reference information of the second video frame, where the reference information includes position information and feature information corresponding to a target area in the second video frame.

In some other implementations, the second determining module 404 crops the first video frame based on the target area to obtain the target video frame by:
if the target object does not exist in the target area, cropping the first video frame into a target video frame with a size that satisfies a preset aspect ratio; and if the target object exists in the target area, generating a target box covering the target object and having a size that satisfies the preset aspect ratio, and cropping the first video frame into the target video frame based on the target box.

In some other implementations, the second determining module 404 crops the first video frame into the target video frame based on the target box by: correcting a position of the target box based on Kalman filtering, to obtain a corrected target box, and cropping the first video frame into the target video frame according to the corrected target box.

In some other implementations, the second determining module 404 is configured to: when the first video frame is a video frame of a recorded video, acquire a target material corresponding to the first video frame, where the target video frame is the target material.

For the apparatus embodiments, since they basically correspond to the method embodiments, reference may be made to the description of the method embodiments for related parts. The apparatus embodiments described above are only schematic, and the units described as separate parts may or may not be physically separated, and the parts displayed as units may or may not be physical units, that is, they may be located in one place, or may be distributed on multiple network units. Some or all of the modules may be selected according to actual needs to achieve the purpose of the solutions of the embodiments of the present disclosure. Those of ordinary skill in the art can understand and implement without creative effort.

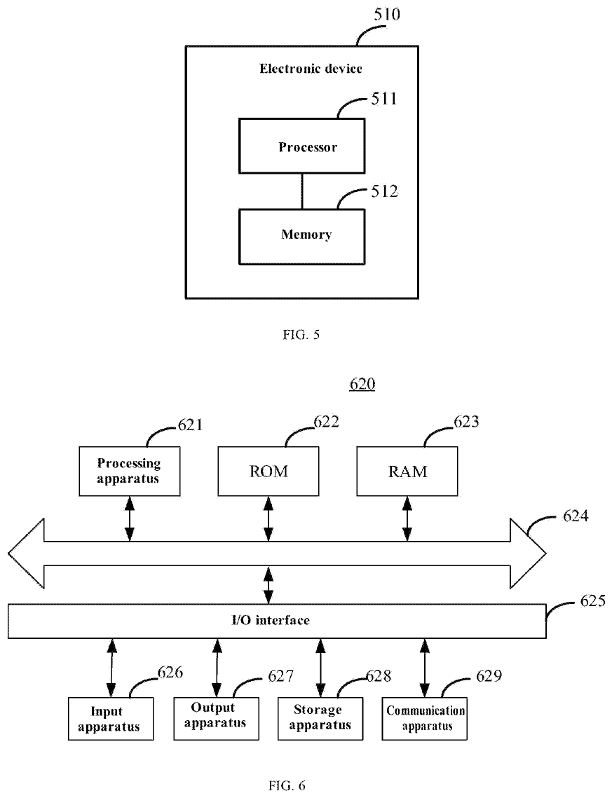

FIG. 5 is a schematic block diagram of an electronic device according to some embodiments of the present disclosure. As shown in FIG. 5, the electronic device 510 includes a processor 511 and a memory 512, which can be used to implement a client or a server. The memory 512 is configured to store computer-executable instructions (for example, one or more computer program modules) non-transiently. The processor 511 is configured to run the computer-executable instructions, and when the computer-executable instructions are run by the processor 511, one or more steps of the video processing method described above may be executed, thereby implementing the video processing method described above. The memory 512 and the processor 511 may be interconnected through a bus system and/or other forms of connection mechanisms (not shown).

For example, the processor 511 may be a central processing unit (CPU), a graphics processing unit (GPU), or other forms of processing units with data processing capabilities and/or program execution capabilities. For example, the central processing unit (CPU) may be an X86 or ARM architecture, etc. The processor 511 may be a general-purpose processor or a dedicated processor, and can control other components in the electronic device 510 to perform desired functions.

For example, the memory 512 may include any combination of one or more computer program products, and the computer program products may include various forms of computer-readable storage media, such as volatile memory and/or non-volatile memory. The volatile memory may include, for example, a random access memory (RAM) and/or a cache memory, etc. The non-volatile memory may include, for example, a read-only memory (ROM), a hard disk, an erasable programmable read-only memory (EPROM), a portable compact disk read-only memory (CD-ROM), a USB memory, a flash memory, etc. One or more computer program modules may be stored on the computer-readable storage medium, and the processor 511 can run one or more computer program modules to implement various functions of the electronic device 510. Various applications and various data and various data used and/or generated by the applications may also be stored in the computer-readable storage medium.

It should be noted that in the embodiments of the present disclosure, reference may be made to the above description of the video processing method for the specific function and technical effect of the electronic device 510, which will not be repeated here.

FIG. 6 is a schematic block diagram of another electronic device according to some embodiments of the present disclosure. The electronic device 620 is, for example, suitable for implementing the video processing method provided by the embodiments of the present disclosure. The electronic device 620 may be a terminal device, etc., and may be configured to implement a client or a server. The electronic device 620 may include, but is not limited to, mobile terminals such as a mobile phone, a laptop, a digital broadcast receiver, a PDA (personal digital assistant), a PAD (tablet computer), a PMP (portable multimedia player), a vehicle-mounted terminal (such as a vehicle-mounted navigation terminal), a wearable electronic device, etc., and fixed terminals such as a digital TV, a desktop computer, a smart home device, etc. It should be noted that the electronic device 620 shown in FIG. 6 is only an example, and it will not impose any limitation to the function and scope of use of the embodiments of the present disclosure.

As shown in FIG. 6, the electronic device 620 may include a processing apparatus (such as a central processing unit, a graphics processor, etc.) 621, which can perform various appropriate actions and processing according to a program stored in a read-only memory (ROM) 622 or a program loaded from a storage apparatus 628 into a random access memory (RAM) 623. Various programs and data required for the operation of the electronic device 620 are also stored in the RAM 623. The processing apparatus 621, the ROM 622, and the RAM 623 are connected to each other through a bus 624. An input/output (I/O) interface 625 is also connected to the bus 624.

Generally, the following apparatuses may be connected to the I/O interface 625: an input apparatus 626 including, for example, a touchscreen, a touchpad, a keyboard, a mouse, a camera, a microphone, an accelerometer, a gyroscope, etc. ; an output apparatus 627 including, for example, a liquid crystal display (LCD), a speaker, a vibrator, etc. ; a storage apparatus 628 including, for example, a magnetic tape, a hard disk, etc. ; and a communication apparatus 629. The communication apparatus 629 may allow the electronic device 620 to perform wireless or wired communication with other electronic devices to exchange data. Although FIG. 6 shows the electronic device 620 with various means, it should be understood that it is not required to implement or have all the illustrated apparatuses, and the electronic device 620 may alternatively implement or have more or fewer apparatuses.

For example, according to the embodiments of the present disclosure, the above video processing method may be implemented as a computer software program. For example, an embodiment of the present disclosure includes a computer program product, which includes a computer program carried on a non-transitory computer-readable medium, and the computer program includes program code for executing the above video processing method. In such an embodiment, the computer program may be downloaded and installed from a network through the communication apparatus 629, or installed from the storage apparatus 628, or installed from the ROM 622. When the computer program is executed by the processing apparatus 621, the functions defined in the video processing method provided by the embodiments of the present disclosure may be implemented.

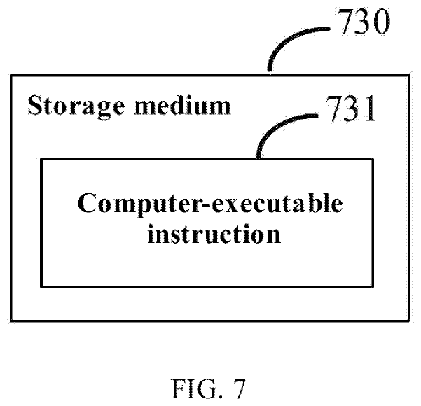

FIG. 7 is a schematic diagram of a storage medium according to some embodiments of the present disclosure. For example, as shown in FIG. 7, the storage medium 730 may be a non-transitory computer-readable storage medium, configured to store a non-transitory computer-executable instruction 731. When the non-transitory computer-executable instruction 731 is executed by a processor, the video processing method described in the embodiments of the present disclosure may be implemented, for example, when the non-transitory computer-executable instruction 731 is executed by a processor, one or more steps according to the above video processing method may be executed.

For example, the storage medium 730 may be applied to the above electronic device, for example, the storage medium 730 may include the memory in the electronic device.

For example, the storage medium may include a memory card of a smart phone, a storage component of a tablet computer, a hard disk of a personal computer, a random access memory (RAM), a read-only memory (ROM), an erasable programmable read-only memory (EPROM), a portable compact disk read-only memory (CD-ROM), a flash memory, or any combination of the above storage media, or may also be other applicable storage media.

For example, reference may be made to the description of the memory in the embodiment of the electronic device for the description of the storage medium 730, and details will not be repeated for repeated parts. Reference may be made to the above description of the video processing method for the specific function and technical effect of the storage medium 730, which will not be repeated here.

It should be noted that, in the context of the present disclosure, the computer-readable medium may be a tangible medium that may contain or store a program for use by or in combination with an instruction execution system, apparatus or device. The computer-readable medium may be a computer-readable signal medium or a computer-readable storage medium, or any combination thereof. The computer-readable storage medium may be, for example, but not limited to, an electrical, magnetic, optical, electromagnetic, infrared, or semiconductor system, apparatus or device, or any combination thereof. More specific examples of the computer-readable storage medium may include, but are not limited to, an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program that may be used by or in combination with an instruction execution system, apparatus or device. In the present disclosure, the computer-readable signal medium may include a data signal propagated in baseband or as part of a carrier wave, in which computer-readable program codes are carried. Such propagated data signals may take a variety of forms, including but not limited to electromagnetic signals, optical signals, or any suitable combination thereof. The computer-readable signal medium may also be any computer-readable medium other than the computer-readable storage medium. The computer-readable signal medium may send, propagate, or transmit a program for use by or in combination with an instruction execution system, apparatus or device. The program codes contained on the computer-readable medium may be transmitted by any suitable medium, including but not limited to an electric wire, an optical cable, a radio frequency (RF), etc., or any suitable combination thereof.

Other implementations of the present disclosure will be easily conceived by those skilled in the art after considering the specification and practicing the invention disclosed herein. The present disclosure is intended to cover any variations, uses, or adaptive changes of the present disclosure. These variations, uses, or adaptive changes follow the general principles of the present disclosure and include common general knowledge or conventional technical means in the technical field that are not disclosed in the present disclosure. The specification and the embodiments are only considered as exemplary, and the true scope and spirit of the present disclosure are indicated by the claims.

It should be understood that the present disclosure is not limited to the precise structure that has been described above and shown in the drawings, and various modifications and changes may be made without departing from the scope thereof. The scope of the present disclosure is limited only by the appended claims.

1. A video processing method, the method comprising:
acquiring a target set, wherein the target set comprises a first feature vector corresponding to a target object, and the first feature vector is obtained based on an image corresponding to the target object;
acquiring a first video frame to be played;
determining a target feature vector of the first video frame; and
determining, based on the target set and the target feature vector, a target video frame associated with the first video frame.

2. The method according to claim 1, wherein the determining, based on the target set and the target feature vector, the target video frame associated with the first video frame comprises:
determining a target area in the first video frame based on the target set and the target feature vector; and
cropping the first video frame based on the target area to obtain the target video frame.

3. The method according to claim 2, wherein the determining the target area in the first video frame based on the target set and the target feature vector comprises:
performing, in the first video frame, area positioning for the target object based on at least the target set and the target feature vector, to obtain at least one target area in the first video frame.

4. The method according to claim 3, wherein the performing, in the first video frame, the area positioning for the target object based on at least the target set and the target feature vector comprises:
in response that the target object does not appear in a second video frame which is a previous frame of the first video frame, performing, in the first video frame, the area positioning for the target object based on the target set and the target feature vector; and
in response that the target object appears in the second video frame, performing, in the first video frame, the area positioning for the target object based on the target set, the target feature vector, and reference information of the second video frame, wherein the reference information comprises position information and feature information corresponding to a target area in the second video frame.

5. The method according to claim 2, wherein the cropping the first video frame based on the target area to obtain the target video frame comprises:
in response that the target object does not exist in the target area, cropping the first video frame into a target video frame with a size that satisfies a preset aspect ratio; and
in response that the target object exists in the target area, generating a target box covering the target object and having a size that satisfies the preset aspect ratio, and cropping the first video frame into the target video frame based on the target box.

6. The method according to claim 5, wherein the cropping the first video frame into the target video frame based on the target box comprises:
correcting a position of the target box based on Kalman filtering, to obtain a corrected target box; and
cropping the first video frame into the target video frame according to the corrected target box.

7. The method according to claim 1, wherein the determining, based on the target set and the target feature vector, the target video frame associated with the first video frame comprises:
in case that the first video frame is a video frame of a recorded video, acquiring a target material corresponding to the first video frame, wherein the target video frame is the target material.

8. (canceled)

9. A non-transitory computer-readable storage medium, storing a computer program thereon, wherein when the computer program is executed by a computer, the computer is caused to execute a video processing method, the method comprising:
acquiring a target set, wherein the target set comprises a first feature vector corresponding to a target object, and the first feature vector is obtained based on an image corresponding to the target object;
acquiring a first video frame to be played;
determining a target feature vector of the first video frame; and
determining, based on the target set and the target feature vector, a target video frame associated with the first video frame.

10. An electronic device, comprising a memory and a processor, wherein the memory stores executable codes, and when the processor executes the executable codes, a video processing method is implemented, the method comprising:
acquiring a target set, wherein the target set comprises a first feature vector corresponding to a target object, and the first feature vector is obtained based on an image corresponding to the target object;
acquiring a first video frame to be played;
determining a target feature vector of the first video frame; and
determining, based on the target set and the target feature vector, a target video frame associated with the first video frame.

11. The medium according to claim 9, wherein the determining, based on the target set and the target feature vector, the target video frame associated with the first video frame comprises:
determining a target area in the first video frame based on the target set and the target feature vector; and
cropping the first video frame based on the target area to obtain the target video frame.

12. The medium according to claim 11, wherein the determining the target area in the first video frame based on the target set and the target feature vector comprises:
performing, in the first video frame, area positioning for the target object based on at least the target set and the target feature vector, to obtain at least one target area in the first video frame.

13. The medium according to claim 12, wherein the performing, in the first video frame, the area positioning for the target object based on at least the target set and the target feature vector comprises:
in response that the target object does not appear in a second video frame which is a previous frame of the first video frame, performing, in the first video frame, the area positioning for the target object based on the target set and the target feature vector; and
in response that the target object appears in the second video frame, performing, in the first video frame, the area positioning for the target object based on the target set, the target feature vector, and reference information of the second video frame, wherein the reference information comprises position information and feature information corresponding to a target area in the second video frame.

14. The medium according to claim 11, wherein the cropping the first video frame based on the target area to obtain the target video frame comprises:
in response that the target object does not exist in the target area, cropping the first video frame into a target video frame with a size that satisfies a preset aspect ratio; and
in response that the target object exists in the target area, generating a target box covering the target object and having a size that satisfies the preset aspect ratio, and cropping the first video frame into the target video frame based on the target box.

15. The medium according to claim 14, wherein the cropping the first video frame into the target video frame based on the target box comprises:
correcting a position of the target box based on Kalman filtering, to obtain a corrected target box; and
cropping the first video frame into the target video frame according to the corrected target box.

16. The medium according to claim 9, wherein the determining, based on the target set and the target feature vector, the target video frame associated with the first video frame comprises:
in case that the first video frame is a video frame of a recorded video, acquiring a target material corresponding to the first video frame, wherein the target video frame is the target material.

17. The device according to claim 10, wherein the determining, based on the target set and the target feature vector, the target video frame associated with the first video frame comprises:
determining a target area in the first video frame based on the target set and the target feature vector; and
cropping the first video frame based on the target area to obtain the target video frame.

18. The device according to claim 17, wherein the determining the target area in the first video frame based on the target set and the target feature vector comprises:
performing, in the first video frame, area positioning for the target object based on at least the target set and the target feature vector, to obtain at least one target area in the first video frame.

19. The device according to claim 18, wherein the performing, in the first video frame, the area positioning for the target object based on at least the target set and the target feature vector comprises:
in response that the target object does not appear in a second video frame which is a previous frame of the first video frame, performing, in the first video frame, the area positioning for the target object based on the target set and the target feature vector; and
in response that the target object appears in the second video frame, performing, in the first video frame, the area positioning for the target object based on the target set, the target feature vector, and reference information of the second video frame, wherein the reference information comprises position information and feature information corresponding to a target area in the second video frame.

20. The device according to claim 17, wherein the cropping the first video frame based on the target area to obtain the target video frame comprises:
in response that the target object does not exist in the target area, cropping the first video frame into a target video frame with a size that satisfies a preset aspect ratio; and
in response that the target object exists in the target area, generating a target box covering the target object and having a size that satisfies the preset aspect ratio, and cropping the first video frame into the target video frame based on the target box.

21. The device according to claim 20, wherein the cropping the first video frame into the target video frame based on the target box comprises:
correcting a position of the target box based on Kalman filtering, to obtain a corrected target box; and
cropping the first video frame into the target video frame according to the corrected target box.
